(19) United States
(12) Patent Application Publication
(10) Pub. No.: US 2025/0224266 A1
(43) Pub. Date: Jul. 10, 2025

(54) 3D PRINTED SIGHT-GLASS FOR CHEMICAL DOSING APPLICATION

(71) Applicant: SAUDI ARABIAN OIL COMPANY, Dhahran (SA)

(72) Inventors: Faisal M. Alshammari, Dhahran (SA); Abdullah S. Bahlas, Al Khobar (SA); Joao A. Tavares, Dhahran (SA); Fahad N. Almaimoni, Riyadh (SA)

(73) Assignee: SAUDI ARABIAN OIL COMPANY, Dhahran (SA)

(21) Appl. No.: 18/404,722

(22) Filed: Jan. 4, 2024

(51) Int. Cl. G01F 23/02; B33Y 10/00; B33Y 80/00

(52) U.S. Cl. CPC G01F 23/02; B33Y 10/00; B33Y 80/00

(57) ABSTRACT

A sight glass may include a body. The sight glass may further include a first tapered section connected to the body and a second tapered section connected to the body. The body, the first tapered section, and the second tapered section are each hollow and continuously formed of a material. A method of making a sight glass may include connecting a body to each of a first taper, and a second taper. The body, the first tapered section, and the second tapered section each may be hollow. The connecting may include continuously forming the body, the first taper, and the second tapered section from a material.

### BACKGROUND

A sight glass can be used to measure the volume of a chemical being dosed to a boiler in a plant. A typical sight glass includes multiple components that are joined together. Due to its many components, this typical sight glass has many potential areas of seepages, which tends to cause many leakages within a plant.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a sight glass. The sight glass may include a body. The sight glass may further include a first tapered section connected to the body and a second tapered section connected to the body. The body, the first tapered section, and the second tapered section are each hollow and continuously formed of a material.

In another aspect, embodiments disclosed herein relate to a method of making a sight glass. The method may include connecting a body to each of a first taper, and a second taper. The body, the first tapered section, and the second tapered section each may be hollow. Connecting the body, the first tapered section, and the second tapered section (also termed “the connecting”) may include continuously forming the body, the first taper, and the second tapered section from a material.

Other aspects and advantages of the claimed subject matter will be apparent from the following description and the appended claims.

### BRIEF DESCRIPTION OF DRAWINGS

FIG. 1 shows a schematic diagram illustrating a sight glass in accordance with one or more embodiments of this disclosure.

FIG. 2 shows a schematic diagram illustrating an exemplary sight glass in accordance with one or more embodiments of this disclosure and a comparative sight glass.

FIG. 3 shows a schematic diagram illustrating the exemplary sight glass of FIG. 2 installed in a plant accordance with one or more embodiments of this disclosure.

FIG. 4 shows a schematic diagram illustrating the comparative sight glass of FIG. 2 installed in the same location of the same plant as shown in FIG. 3.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

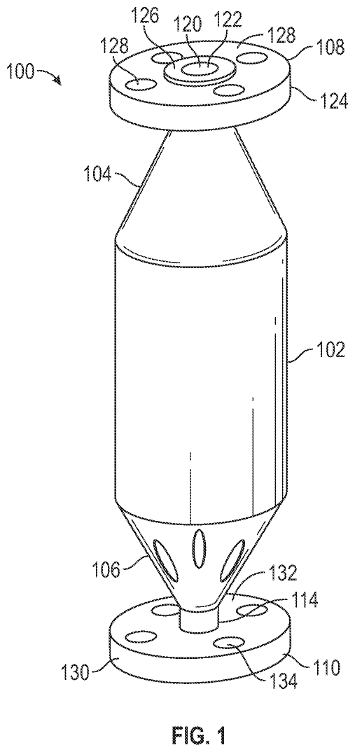

FIG. 1 shows a schematic diagram illustrating a sight glass according to one or more embodiments. As shown in FIG. 1, the sight glass 100 includes a plurality of sections continuously formed of a material. Sight glass 100 is thus a single component made up of the sections which are consolidated into the single component. As used herein “single” component refers to the component being formed of the material, wherein the material is common to the sections consolidated into the component. As shown in FIG. 1, the sections of sight glass 100 include a body 102, a first tapered section 104, a second tapered section 106, a first flange 108, and a second flange 110, a first pipe (not shown), and a second pipe 114. The sight glass 100 may have an end to end length suitable to fit in the physical space available within a plant where sight glass 100 is deployed. The end to end length of the sight glass 100 may have a tolerance. For example, when a target value of the end to end length of the sight glass 100 is 12 inches and the tolerance is about 1 inch the end to end length may an end to end length between about 11.5 inches and about 12.5 inches. It will be understood that 12 inches is an exemplary end to end length. If there is a larger space available in the plant, the sight glass 100 is longer. If there is a small space available in the plant, the sight glass 100 is shorter.

Still referring to FIG. 1, the body 102 is hollow. Thus, the body 102 defines a space therethrough. The body 102 is shaped as an annular cylinder. It will be understood that alternative shapes may be used, however an annular cylinder shape optimizes efficiency. The body 102 has an inner surface and an outer surface. The body 102 includes a wall of the material between the outer surface and the inner surface having a thickness extending between the inner surface and the outer surface. The body 102 may have a wall thickness suitable to withstand internal pressure. For example, the wall thickness of body 102 may be between about 0.2 inches and about 0.3 inches. The body 102 includes a first end and a second end opposing the first end. The body 102 may have an end to end length suitable to fit within the physical space available within a plant where body 102 is deployed. The end to end length of the body 102 may have a tolerance. For example, when a target value of the end to end length of the body 102 is 5.4 inches and the tolerance is about 0.1 inch the end to end length may an end to end length between about 5.35 inches and about 5.45 inches. It will be understood that 5.4 inches is an exemplary end to end length. If there is a larger space available in the plant, the body 102 is longer. If there is a small space available in the plant, the body 102 is shorter.

Still referring to FIG. 1, the first tapered section 104 is hollow. Thus, the first tapered section 104 defines a space therethough. The space through the first tapered section 104 is contiguous with the space through the body 102. As shown in FIG. 1, the first tapered section 104 is shaped as an annular cone. The first tapered section 104 has an inner surface and an outer surface. The inner surface of the first tapered section 104 is connected to the inner surface of the body 102, and the outer surface of the first tapered section 104 is connected to the outer surface of the body 102. The first tapered section 104 includes a wall of the material between the outer surface and the inner surface having a thickness extending between the inner surface and the outer surface. The first tapered section 104 may have a wall thickness suitable to withstand internal pressure. Wall thickness may be a constant within sight glass 100. Thus, the wall thickness of first tapered section 104 may be the same as the wall thickness of body 102. For example, the wall thickness of first tapered section 104 may be between about 0.2 inches and about 0.3 inches. The first tapered section 104 includes a narrower end and a wider end opposing the first end. The wider end of first tapered section 104 is connected to the first end of the body 102. The first tapered section 104 may have an end to end length extending from the narrower end to the wider end suitable to fit within the physical space available within a plant where first tapered section 104 is deployed. The end to end length of the first tapered section 104 may have a tolerance. For example, when a target value of the end to end length of the first tapered section 104 is 2.25 inches and the tolerance is about 0.25 inch the end to end length may an end to end length between about 2 inches and about 2.5 inches. It will be understood that 2.25 inches is an exemplary end to end length. If there is a larger space available in the plant, the first tapered section 104 is longer. If there is a small space available in the plant, the first tapered section 104 is shorter. The first tapered section 104 may have an angle of taper suitable to the end to end length of the first tapered section 104. For example, first tapered section 104 between about 28° (Degrees) and about 30° (Degrees). As shown in FIG. 1, the angle of taper is constant along the length of the first tapered section 104.

Still referring to FIG. 1, the second tapered section 106 is hollow. Thus, the second tapered section 106 defines a space therethough. The space through the second tapered section 106 is contiguous with the space through the body 102. As shown in FIG. 1, the first tapered section 106 is shaped as an annular cone. The second tapered section 106 has an inner surface and an outer surface. The inner surface of the second tapered section 106 is connected to the inner surface of the body 102, and the outer surface of the second tapered section 106 is connected to the outer surface of the body 102. The second tapered section 106 includes a wall of the material between the outer surface and the inner surface having a thickness extending between the inner surface and the outer surface. The second tapered section 106 may have a wall thickness suitable to withstand internal pressure. Wall thickness may be a constant within sight glass 100. Thus, the wall thickness of second tapered section 106 may be the same as the wall thickness of first tapered section 104. For example, the wall thickness of second tapered section 106 may be between about 0.2 inches and about 0.3 inches. The second tapered section 106 includes a narrower end and a wider end opposing the first end. The wider end of the second tapered section 106 is connected to the second end of the body 102. The second tapered section 106 may have an end to end length extending from the narrower end to the wider end suitable to fit within the physical space available within a plant where second tapered section 106 is deployed. The end to end length of the second tapered section 106 may have a tolerance. For example, when a target value of the end to end length of the second tapered section 106 is 2.25 inches and the tolerance is about 0.25 inch the end to end length may an end to end length between about 2 inches and about 2.5 inches. It will be understood that 2.25 inches is an exemplary end to end length. If there is a larger space available in the plant, the second tapered section 106 is longer. If there is a small space available in the plant, the second tapered section 106 is shorter. The second tapered section 106 may have an angle of taper suitable to the end to end length of the first tapered section 104. For example, second tapered section 106 between about 28° (Degrees) and about 30° (Degrees). As shown in FIG. 1, the angle of taper is constant along the length of the second tapered section 106. The second tapered section 106 may be symmetrical with first tapered section 104.

Still referring to FIG. 1, the first flange 108 includes a void 122 therethrough and is connected to the first tapered section 104 at the narrower end of the first tapered section 104. The first flange 108 includes an inner surface defining the void 122, where the inner surface of the first flange 108 is connected to the inner surface of the first tapered section 104 at the narrower end of the first tapered section 104. The void 122 is centered in the first flange 108. The void 122 is cylindrical. It will be understood that alternative shapes may be used, however a cylindrical shape optimizes efficiency. The void 122 is contiguous with the space through the first tapered section 106. First flange 108 includes perimeter 124. The perimeter 124 is circular. The first flange 108 includes an outward surface 128 and an inward surface (not shown). The outward surface 128 faces away from body 102. The inward surface faces towards body 102. The first flange 108 includes a lip 126. The lip 126 extends from exterior surface 128. The lip 126 has an annular shape. The lip 126 has an inner surface that is included in the inner surface defining the void 122 centered in the first flange 108. The first flange 108 includes a plurality of holes 128 therethrough. The holes 128 are arrayed around void 122 between perimeter 124 and lip 126. As shown, in FIG. 1, the flange 108 includes four holes 128. It will be understood that an alternate suitable number of holes may be used. The holes 128 are evenly spaced apart. The even spacing maintains equal distribution of pressure on the face of first flange 108. The first flange 108 is configured to be capable of attaching sight glass 102 into an apparatus.

Still referring to FIG. 1, the second flange 110 includes a void therethrough and is connected to the second tapered section 106 at the narrower end of the second tapered section 106. The second flange 110 includes an inner surface defining a void (not shown) through the second flange 110, where the inner surface of the second flange 110 is connected to the inner surface of the second tapered section 106 at the narrower end of the second tapered section 106. The void is centered in the second flange 110. The void is cylindrical. It will be understood that alternative shapes may be used, however a cylindrical shape optimizes efficiency. The void is contiguous with the space through the second tapered section 108. The second flange 110 includes perimeter 130. The perimeter 130 is circular. The second flange 110 includes an outward surface (not shown) and an inward surface 132. The outward surface faces away from body 102. The inward surface 132 faces towards body 102. The second flange 110 includes a lip (not shown). The lip extends from exterior surface 128. The lip has an annular shape. The lip has an inner surface that is included in the inner surface defining the void centered in the second flange 110. The second flange 110 includes a plurality of holes 134 therethrough. The holes 134 are arrayed around void 122 between perimeter 130 and the lip included in the second flange 110. Although FIG. 1 shows three holes, second flange 110 includes four holes 134. It will be understood that an alternate suitable number of holes may be used. The holes 134 are evenly spaced apart. The even spacing maintains equal distribution of pressure on the face of second flange 110. The second flange 110 is configured to be capable of attaching sight glass 102 into an apparatus. The second flange 110 may be symmetrical with first flange 108.

Still referring to FIG. 1, the first pipe (not shown) is connected to the first tapered section 104 and the first flange 108 between the first tapered section 104 and the first flange 108. The first tapered section 104 and the first flange 108 and are connected to each other via the first pipe. The first pipe defines a space therethrough that is contiguous with the space defined by the first tapered section 104 and contiguous with the void through the first flange 108. An inner surface of the first pipe and the inner surface 120 of the first flange 108 have matching cross-sectional sizes. Thus, an inner diameter of the first pipe matches a diameter of the void 122 through the first flange 108. The first pipe defines a hollow space therethrough contiguous with the hollow space defined by the first tapered section 104 and contiguous with the void through the first flange 108.

Still referring to FIG. 1, the second pipe 114 is connected to the second tapered section 106 and the second flange 110 between the second tapered section 106 and the second flange 110. The second tapered section 106 and the second flange 110 and are connected to each other via the second pipe 114. The second pipe 114 defines a space therethrough that is contiguous with the space defined by the second tapered section 106 and contiguous with the void through the second flange 110. An inner surface of the second pipe 114 and the inner surface of the second flange 110 have matching cross-sectional sizes. Thus, an inner diameter of the second pipe 114 matches a diameter of the void 122 through the second flange 110. The second pipe 114 defines a hollow space therethrough contiguous with the hollow space defined by the second tapered section 106 and contiguous with the void through the second flange 110.

The material of sight glass 100 may be sufficiently transparent so the fluid within sight glass may be viewed. The material may be translucent. The material may include one or more polymers and/or co-polymers. Thus, the material may be polymeric. When the material is polymeric, the material may include polypropylene. When the material is polymeric, the material may include a cured clear resin. The clear resin may be polypropylene resin. It will be understood that other clear resins are suitable that result in sufficient transparency for sight glass 100. The clear resin may be selected to provide chemical compatibility between the resin material and a service fluid passing through sight glass 100.

A method of making the sight glass 100 may include connecting the sections of the sight glass 100 wherein the connecting includes continuously forming the sections from the material. It will be understood that continuously forming as used herein means consolidating the sections of the sight glass into a single component making up the sight glass. As noted above, as used herein “single” component refers to the component being formed of the material, wherein the material is common to the sections consolidated into the component. It will be understood that continuously forming the sections from a material may involve multiple stages. For example, the continuous forming may include building the walls of the sections in staged layers from the material. Further, the material may be provided as a precursor that is treated, for example by curing, to obtain the material. A suitable method of continuously forming sections of sight glass 100 from a material is 3D printing. Thus, continuously forming sections of sight glass 100 from a material may include delivering a clear resin to a 3D printer, printing the sections from the clear resin with the 3D printer, and curing the resin to form the material. A known 3D printing process may be used. For example, the 3D printing may be a sterolithography (SLA) process.

The method may include connecting the body 102 to each of the first tapered section 104 and the second tapered section 106. Connecting the body 102 to each of the first tapered section 104 and the second tapered section 106 includes continuously forming the body 102, the first tapered section 104 and the second tapered section 106 from the material.

The method may include connecting the first end of the body 102 to the wider end of the first tapered section 104 and connecting the second end of the body 102 to the wider end of the second taper 106. Connecting the first end of the body 102 to the wider end of the first tapered section 104 includes continuously forming the body 102 and the first tapered section 104 from the material. Connecting the second end of the body 102 to the wider end of the second tapered section 106 includes continuously forming the body 102 and the second tapered section 106 from the material.

The method may include connecting the first flange 108 to the first tapered section 104 at the narrower end of the first tapered section 104 and connecting the second flange 110 to the second tapered section 106 at the narrower end of the second tapered section 106. Connecting the first flange 108 to the first tapered section 104 includes continuously forming the second flange 110 and the second tapered section 106 from the material. Connecting the second flange 110 to the second tapered section 106 includes continuously forming the second flange 110 and the second tapered section 106 from the material.

The method may include connecting the first pipe to the first tapered section 104 and the first flange 108 between the first tapered section 104 and the first flange 108 and connecting the second pipe 114 to the second tapered section 106 and the second flange 110 between the second pipe 114 and the second tapered section 106. Connecting the first pipe to the first tapered section 104 and the first flange 108 includes continuously forming the first pipe, the first tapered section 104 and the first flange 108 from the material. Connecting the second pipe 114 to the second tapered section 106 and the second flange 110 includes continuously forming the second pipe 114, the second tapered section 106, and the second flange 110 from the material.

A method of using the sight glass 100 may include attaching the sight glass 100 to an apparatus. The apparatus may be a portion of or attached to a boiler. The boiler may be in a plant. The plant may be a plant that includes a system that injects phosphate solution to remove scales that build up in the inner surfaces of boilers in the plant. Thus, sight glass 100 may be part of a cleaning system for boilers in the plant. The sight glass 100 may be used to measure the flow volume of a fluid in the boiler. The fluid may be phosphate solution used to remove scale build up in the boiler. The present inventors have observed that polypropylene is a suitable material for sight glass 100 when used to measure the flow of phosphate solution. It will be understood that other materials may be selected according to the fluid, when the flow of another fluid is measured.

The following examples are intended for illustrative purposes and are not intended to limit the scope of this invention.

### Examples

The following example describes an exemplary sight glass including a single consolidated component formed of a polymeric material, where the polymeric material is polypropylene. This example demonstrates eradication of the issue of recurring leakage when measuring fluid volumes using the exemplary sight glass.

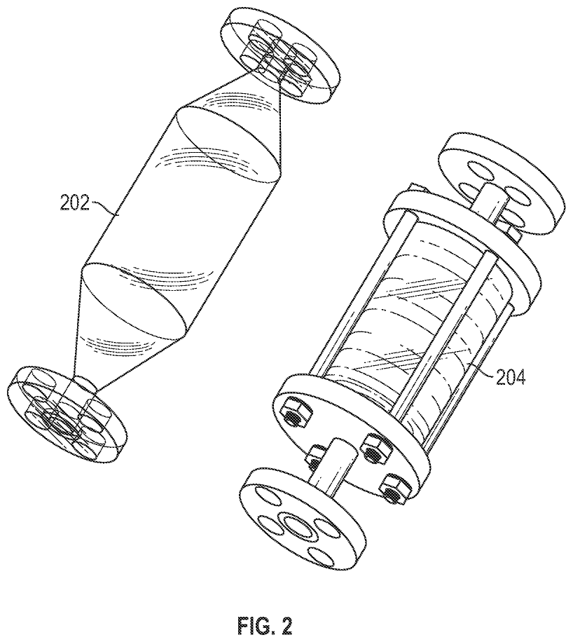

FIG. 2 shows a side-by-side comparison of an exemplary sight glass 202 and a comparative sight glass 204, which highlights the improvements made in the construction of the sight glass.

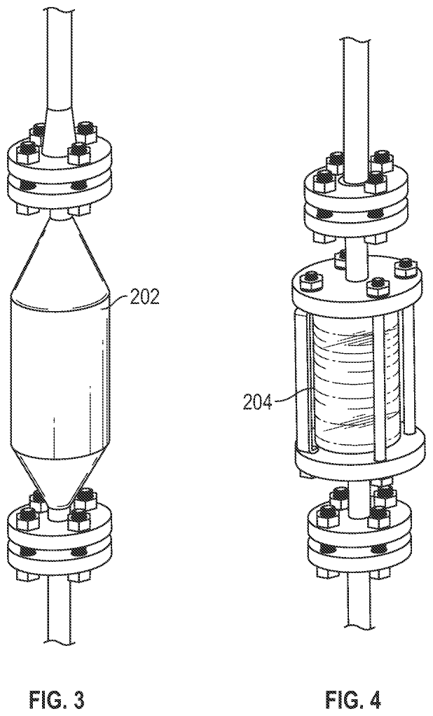

FIG. 3 shows the exemplary sight glass 202 deployed in the field and FIG. 4 shows the comparative sight glass 204 deployed in the field. Using the single 3D printed component that consolidated sections of the exemplary sight glass 202 from a single common polypropylene material solved the problem of leakages from the comparative sight glass 204. Because the 3D printing method consolidates all sections into a single merged component that is the sight glass 202, so there are no potential areas for seepages.

The exemplary sight glass 202 was a 3D printed translucent sight glass made of clear XPP405 (polypropylene) resin material. The exemplary sight glass 202 was made according to the design shown in FIG. 1. The exemplary sight glass 202 was manufactured using an SLA-type 3D-printer. All sections of the exemplary sight glass were printed as a single component in clear XPP405 (polypropylene) resin material. Exemplary sight glass 202 was 3D printed using the SLA printing process by using the NEXA3D NXE 400 Pro 3D printer. The exemplary sight glass 202 had an end to end length of 11.8 inches. The exemplary sight glass 202 had a wall thickness of 0.2 inches.

Utilizing 3D printing consolidated all sections of the exemplary sight glass 202 into a single polypropylene component. That is, utilizing 3D printing, the sections of the sight glass were continuously formed from polypropylene. The single polyproline component was translucent. After cleaning and curing the 3D printed part (post-processing), the sight-glass lost some of its transparency and the final-product was translucent in the end.

The comparative sight glass 204 was a sight glass used previously in the field. Comparative sight glass 204 was obtained as a commercially available sight glass from the Milton Roy company. The comparative sight glass 204 included two metallic flanges with a cylindrical glass part in the middle that was ‘sandwiched’ by the two metallic flanges. The two metallic flanges were tightened and secured at the two ends of the cylindrical glass part using four metallic bolts extending between the metallic flanges. In use, especially if the bolts were not all tightened with the same torque values, this sight glass was prone to leak.

The exemplary sight glass 202 had the same height as the comparative sight glass 204. However, in contrast to the separated metal flange-ends and the middle cylindrical glass part in the comparative sight glass, the sections of the exemplary sight glass were merged, thus consolidated, to create a single component continuously formed of polypropylene, removing all potential seepages points and eradicating the issue.

The exemplary sight glass 202 was able to measure the phosphate fluid flow volume. The exemplary sight glass 202 was used to measure the volume of flowing phosphate, as part of the phosphate dosing package being supplied to the plant's boilers. The plant was a plant that included a system that injects phosphate solution to remove scales that build up in the inner surfaces of boilers in the plant. Thus, exemplary sight glass 202 was part of a cleaning system for boilers in the plant. The exemplary sight glass 202 was used to measure the flow volume of a fluid in the boiler. The fluid was a phosphate solution used to remove scale build up in the boiler. The exemplary sight glass 202 was fully able to measure the fluid flow volume without causing seepages. In contrast, the comparative sight glass 204 had an issue of recurring leakage.

Referring to FIG. 3, exemplary sight glass 202 was installed in the field for a period of at least nine months. Within this timeframe, there was been no leakage from the part, thus solving the technical problem of leakage.

Referring to FIG. 4, comparative sight glass 204 was also installed in the field for a similar period of time. Within this timeframe, the sight glass of the previous design leaked. The leakage occurred at least within five months.

Thus, the exemplary sight glass 202 illustrates the technical improvement of achieving the eradication of recurring leakages within the plant, which has been solved by embodiments of the present disclosure.

Embodiments of the present disclosure may provide at least one of the following advantages. The sight glass provides excellent prevention of seepage from the sight glass. For example, the sight glass allows measurement of fluid flow in a plant's boilers without seepage of the fluid from the sight glass during the measurement.

Unless defined otherwise, all technical and scientific terms used have the same meaning as commonly understood by one of ordinary skill in the art to which these systems, apparatuses, methods, processes and compositions belong.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a circuit breaker” includes reference to one or more of such circuit breakers.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

Terms such as “approximately,” “about,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide. For example, these terms may mean that there can be a variance in value of up to +10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

Although multiple dependent claims are not introduced, it would be apparent to one of ordinary skill that the subject matter of the dependent claims of one or more embodiments may be combined with other dependent claims.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A sight glass, comprising:
a body;
a first tapered section connected to the body; and
a second tapered section connected to the body;
wherein the body, the first tapered section, and the second tapered section are each hollow and continuously formed of a material.

2. The sight glass of claim 1, wherein the first tapered section and the second tapered section each independently have a narrower end and a wider end.

3. The sight glass of claim 2, wherein the body has a first end and a second end opposing the first end, wherein the first end is connected to the wider end of the first tapered section and the second end is connected to the wider end of the second taper.

4. The sight glass of claim 2, wherein the component further comprises a first flange and a second flange, wherein the first flange comprises a void therethrough and is connected to the first tapered section at the narrower end of the first tapered section and the second flange comprises a void therethrough and is connected to the second tapered section at the narrower end of the second tapered section.

5. The sight glass of claim 4, wherein the component further comprises a first pipe and a second pipe, wherein the first pipe is connected to the first tapered section and the first flange therebetween and the second pipe is connected to the second tapered section and the second flange therebetween.

6. The sight glass of claim 1, wherein the material is translucent.

7. The sight glass of claim 1, wherein the material comprises a polymer.

8. The sight glass of claim 1, wherein the material comprises polypropylene.

9. The sight glass of claim 1, wherein the material comprises a cured clear resin.

10. A method of making a sight glass, comprising:
connecting a body to each of a first taper, and a second taper, wherein the body, the first taper, and the second tapered section are each hollow, wherein the connecting comprises:
continuously forming the body, the first tapered section, and the second tapered section from a material.

11. The method of claim 10, wherein the first tapered section and the second tapered section each independently have a narrower end and a wider end.

12. The method of claim 11, wherein the body has a first end and a second end opposing the first end, wherein the method comprises connecting the first end of the body to the wider end of the first tapered section and connecting the second end of the body to the wider end of the second taper.

13. The method of claim 11, wherein the component further comprises a first flange and a second flange, wherein the first flange and the second flange each independently have a void therethrough, wherein the method comprises connecting the first flange to the first tapered section at the narrower end of the first tapered section and connecting the second flange to the second tapered section at the narrower end of the second tapered section.

14. The method of claim 13, wherein the component further comprises a first pipe and a second pipe, wherein method comprises connecting the first pipe to the first tapered section and the first flange therebetween and connecting second pipe to the second tapered section and the second flange therebetween.

15. The method of claim 10, wherein the material is translucent.

16. The method of claim 10, wherein the material comprises a polymer.

17. The method of claim 16, wherein the material comprises polypropylene.

18. The method of claim 10, wherein the material comprises a cured clear resin.
